(19) United States
(12) Patent Application Publication
(10) Pub. No.: US 2021/0241330 A1
(43) Pub. Date: Aug. 5, 2021

(54) Pricing Operation Using Artificial Intelligence for Dynamic Price Adjustment

(71) Applicant: salesforce.com, inc., San Francisco, CA (US)

(72) Inventors: Parth Vijay Vaishnav, Newark, CA (US); Mitchell Christensen, Livermore, CA (US)

(21) Appl. No.: 16/779,383

(22) Filed: Jan. 31, 2020

(51) Int. Cl. G06Q 30/02; G06N 3/08

(52) U.S. Cl. CPC G06Q 30/0283; G06Q 30/0206; G06N 3/08

(57) ABSTRACT

Embodiments regard pricing operation using artificial intelligence for price adjustment. An embodiment of one or more mediums include instructions for receiving a request at a pricing platform for pricing of sales items in a sales transaction, including a first sales item; generating a price for the first sales item; and determining whether a dynamic price adjustment function is enabled for the first sales item, and, if so, performing the dynamic adjustment price function for the first sales item, including accessing a trained neural network trained for price adjustments based at least in part on training data including news data from one or more sources and data regarding pricing, receiving a dynamic price adjustment for the first sales item from the trained neural network, and applying the dynamic price adjustment to the generated price to produce an adjusted price for the first sales item.

### TECHNICAL FIELD

Embodiments relate to techniques for computer operations. More particularly, embodiments relate to pricing operation using artificial intelligence for dynamic price adjustment.

### BACKGROUND

In providing support for client operations in a pricing architecture, the architecture is intended to provide assistance. The use of the pricing architecture can provide efficient and effective pricing operations for clients without requiring the design and support of an internal pricing structure for each client.

However, pricing for certain products or services can be affected by many factors that are difficult to incorporated into a conventional pricing service. There may be external factors in the industry, in the general economy, or the world at large that may affect pricing.

If a client wants or needs to take such factors into consideration, the client generally needs to provide price adjustments outside of a general pricing architecture, and is required to relay upon internal data and estimates to determine what price adjustment is needed.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is an illustration of a computing platform including artificial intelligence to provide dynamic price adjustment for sales transactions, according to some embodiments;

FIG. 2 illustrates training and deployment of a neural network to provide dynamic price adjustments in a pricing system according to some embodiments;

FIG. 3 is an illustration of training of a neural network to generate dynamic price adjustments according to some embodiments;

FIG. 4 is an illustration neural network inference to generate dynamic price adjustment according to some embodiments;

FIG. 5 is a flow chart to illustrate a process for generating a trained neural network for performing dynamic price adjustment according to some embodiments;

FIG. 6 is a flow chart to illustrate a process for generating a dynamic price adjustment for a sales item utilizing a trained neural network according to some embodiments;

FIG. 7 illustrates a block diagram of an environment in which dynamic price adjustment may be implemented according to some embodiments; and

FIG. 8 illustrates further details of an environment in which dynamic price adjustment may be implemented according to some embodiments.

### DETAILED DESCRIPTION

In the following description, numerous specific details are set forth. However, embodiments may be practiced without these specific details. In other instances, well-known circuits, structures and techniques have not been shown in detail in order not to obscure the understanding of this description.

In some embodiments, an apparatus, system, or process is to provide dynamic price adjustment using artificial intelligence (AI).

In some embodiments, a system or process for pricing of sales items includes the application of a neural network that is trained to generate dynamic price adjustments, wherein the training of the neural network includes the application of news source data and pricing data to a neural network model to train the neural network to generate dynamic price adjustments. The resulting trained neural network may be utilized to provide an inference operation to generate the price adjustments based one or more news sources, where news sources may include, for example, business news, general news, and social media.

In some embodiments, a dynamic price adjustment function or service enables neural network inference may be based on product demand, sentimental analysis on products, stock market trends, social media mentions, social media influencers, press releases, news articles, and other news data factors to generate appropriate dynamic price adjustments for a particular sales item. The dynamic price adjustment function is to apply machine learning and AI technology to dynamically determine appropriate adjustments to pricing, which may include price discounts and price increases for any particular sales item, or application of a substitute price for the sales item.

In some embodiments, the dynamic price adjustment function may include client setting to further take into account additional factors related to a sales transactions, such as quantity of an order and specifics regarding the delivery of the sales item, in the generation of dynamic price adjustment. For example, the function may recognize that a price adjustment is appropriate with sales of a certain minimum quantity that may not be triggered with a smaller order. Further, the client settings may impose dynamic sales adjustments for certain customers and not others, with, for example, customers providing significant business being excluded from dynamic price adjustment.

In some embodiments, the support for neural network based price adjustment is provided as a part of a pricing infrastructure, with the pricing architecture accessing the trained neural network to obtain inferred price adjustments. The pricing architecture could support operation of the trained neural network, or could access an external network. Neural network training includes input from clients regarding whether to utilize machine learning price adjustment, what news/data sources to access, how much to weigh the pricing adjustments, and other inputs.

A machine learning algorithm is an algorithm that can learn based on a set of data. Embodiments of machine learning algorithms can be designed to model high-level abstractions within a data set. An exemplary type of machine learning algorithm is a neural network. There are many different types of neural networks, including a feedforward network. A feedforward network may be implemented as an acyclic graph in which the nodes are arranged in layers. Typically, a feedforward network topology includes an input layer and an output layer that are separated by at least one hidden layer. The hidden layer transforms input received by the input layer into a representation that is useful for generating output in the output layer. The network nodes are fully connected via edges to the nodes in adjacent layers, but there are no edges between nodes within each layer. Data received at the nodes of an input layer of a feedforward network are propagated (i.e., “fed forward”) to the nodes of the output layer via an activation function that calculates the states of the nodes of each successive layer in the network based on coefficients (referred to as “weights”) respectively associated with each of the edges connecting the layers.

Before a machine learning algorithm can be used to model a particular problem, the algorithm is trained using a training data set. Training a neural network involves selecting a neural network model topology, using a set of training data representing a problem being modeled by the network, and adjusting the weights until the neural network model performs with a minimal error for all instances of the training data set. For example, during a supervised learning training process for a neural network, the output produced by the network in response to the input representing an instance in a training data set is compared to the “correct” labeled output for that instance, an error signal representing the difference between the output and the labeled output is calculated, and the weights associated with the connections are adjusted to minimize that error as the error signal is backward propagated through the layers of the network. The network is considered “trained” when the errors for each of the outputs generated from the instances of the training data set are minimized.

An exemplary type of neural network is a Convolutional Neural Network (CNN). A CNN is a specialized feedforward neural network for processing data having a known, grid-like topology, such as image data. CNNs may be used in, for example, compute vision and image recognition applications, and many other types of pattern recognition such as speech and language processing. The nodes in the CNN input layer are organized into a set of “filters”, and the output of each set of filters is propagated to nodes in successive layers of the network. The computations for a CNN include applying the convolution mathematical operation to each filter to produce the output of that filter. Convolution is a specialized kind of mathematical operation performed by two functions to produce a third function that is a modified version of one of the two original functions. In convolutional network terminology, the first function to the convolution can be referred to as the input, while the second function can be referred to as the convolution kernel. The output may be referred to as the feature map. For example, the input to a convolution layer can be a multidimensional array of data that defines the various color components of an input image. The convolution kernel can be a multidimensional array of parameters, where the parameters are adapted by the training process for the neural network.

Recurrent neural networks (RNNs) are a family of feedforward neural networks that include feedback connections between layers. RNNs enable modeling of sequential data by sharing parameter data across different parts of the neural network. The architecture for a RNN includes cycles. The cycles represent the influence of a present value of a variable on its own value at a future time, as at least a portion of the output data from the RNN is used as feedback for processing subsequent input in a sequence. This feature makes RNNs particularly useful in, for example, language processing due to the variable nature in which language data can be composed.

A deep neural network (DNN), as applied to artificial intelligence (AI) operation, is an artificial neural network that includes multiple neural network layers. Broadly speaking, neural networks operate to spot patterns in data, and provide decisions based on such patterns.

Neural networks may be applied to perform deep learning. Deep learning is machine learning using deep neural networks. The deep neural networks used in deep learning are artificial neural networks composed of multiple hidden layers, as opposed to shallow neural networks that include only a single hidden layer. Deeper neural networks are generally more computationally intensive to train. However, the additional hidden layers of the network enable multistep pattern recognition that results in reduced output error relative to shallow machine learning techniques.

Once a neural network is structured, a learning model can be applied to the network to train the network to perform specific tasks. The learning model describes how to adjust the weights within the model to reduce the output error of the network. Backpropagation of errors is a common method used to train neural networks. An input vector is presented to the network for processing. The output of the network is compared to the desired output using a loss function and an error value is calculated for each of the neurons in the output layer. The error values are then propagated backwards until each neuron has an associated error value which roughly represents its contribution to the original output. The network can then learn from those errors using an algorithm, such as the stochastic gradient descent algorithm, to update the weights of the of the neural network.

In some embodiments, a neural network is trained utilizing training data that relates to news sources and pricing fluctuations, with the output of the neural network being a pricing adjustments for one or more sales items in a sales transaction based on an input of current price conditions, the current price conditions being based at least in part on one or more external data sources.

As used herein, “sales transaction” refers to any sales order or inquiry for one or more sales items, with each sales item including a certain quantity; and “pricing plan” refers to calculations performed to generate pricing for the one or more sales items in a sales transaction.

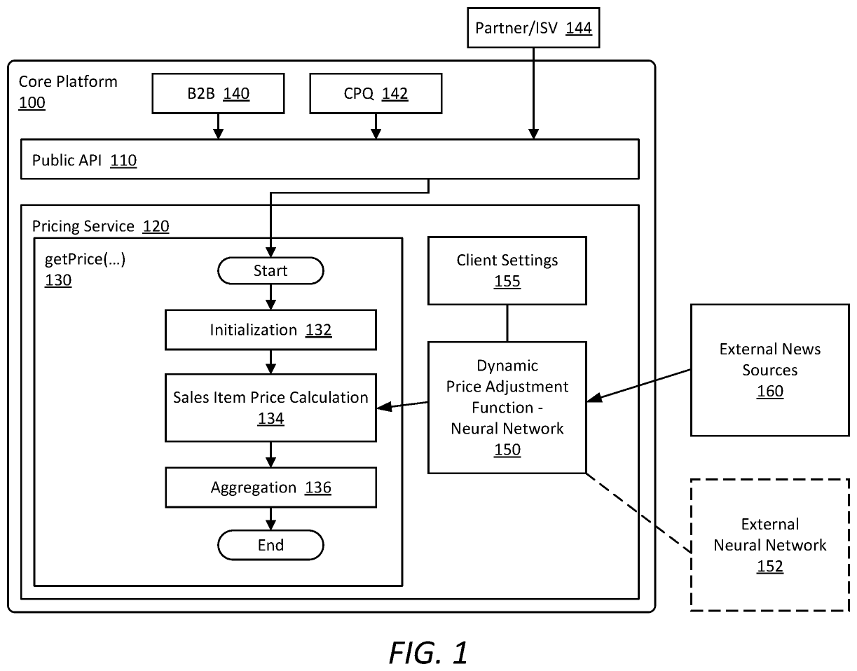

FIG. 1 is an illustration of a computing platform including artificial intelligence to provide dynamic price adjustment for sales transactions, according to some embodiments. As illustrated, a core computing platform 100 may provide multiple services including, but not limited to, a pricing service 120 to provide pricing operations for multiple different types of sales operations. The core platform 100 may include numerous other operations and functions.

The core platform 100 may include a public application program interface (API) 110 for connection of multiple different types of clients that may generate operation requests, including requests to the pricing service 120. The requests may include business to business (B2B) requests 140 and configure-price-quote (CPQ) requests 142 provided within the core platform 100, and partner or independent software vendor (ISV) requests 144 received from outside the core platform 100.

The pricing service 120 in particular includes a getPrice function 130 to determine pricing for one or more sales items in a sales transaction, the sales items being any combination of goods and services. In a basic operation, the getPrice function for a particular request includes initialization of the pricing operation 132, sales price calculation for each sales item of the request 134, which may include the application of a particular pricing plan for the sales item, and aggregation of the pricing calculations to generate a pricing output 136, which may then be provided to the requesting client.

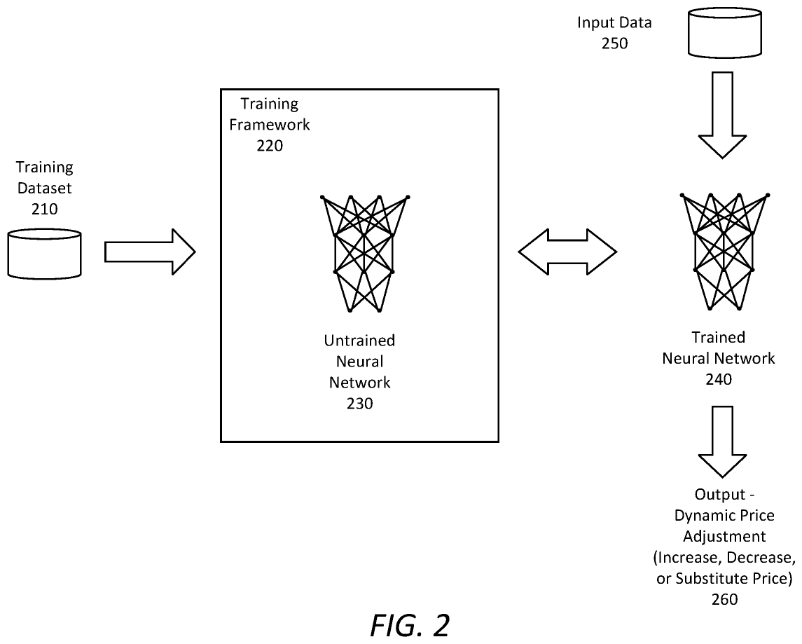

In some embodiments, the pricing service 120 further includes a dynamic price adjustment function 150, the dynamic price adjustment function including a neural network to provide artificial intelligence in price adjustment. The neural network is trained utilizing one or more data streams to determine dynamic price adjustments based at least in part on current pricing conditions, as further illustrated in FIG. 2. A dynamic price adjustment may include a price increase, a price decrease, or application of a substitute price. In some embodiments, the neural network is within the pricing service 120, and in some alternative embodiments the neural network may be an external neural network 152 outside of the pricing service 120.

In some embodiments, the pricing service 120 further includes access to one or more external news sources 160 to receive or obtain input data from one or more news sources for the dynamic price adjustment function 150. In some embodiments, the pricing service includes one or more client settings 155 to control operations of the dynamic price adjustment function. For example, the client settings 155 might enable or disable the operation of the dynamic price adjustment function 150 for the client or for the purposes of certain sales items or sales customers.

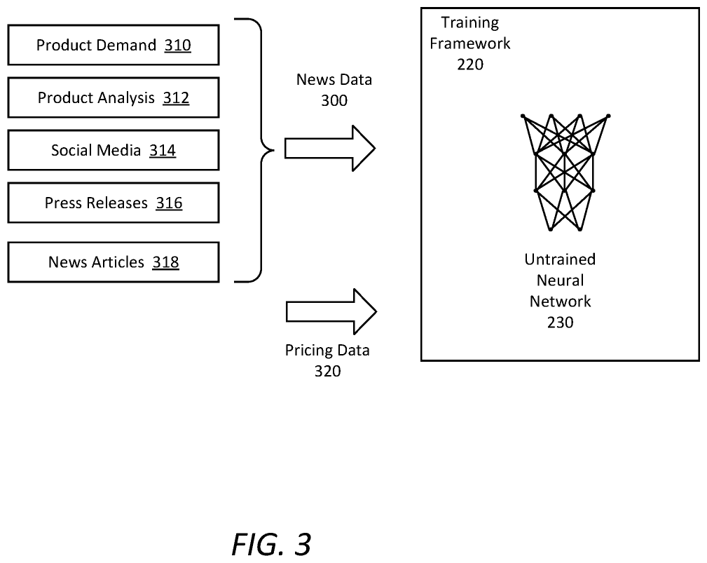

FIG. 2 illustrates training and deployment of a neural network to provide dynamic price adjustments in a pricing system according to some embodiments. In some embodiments, an untrained neural network model 230 in a training framework 220 is trained using a training dataset 210. In some embodiments, the training data set includes news data and pricing data to providing price adjustment training, The training may be as further illustrated in FIG. 3. The training framework 220 operates to train the untrained neural network 230 to generate a trained neural network 240.

The training may proceed according to known techniques. For example, to commence the training process, initial weights may be chosen randomly or by pre-training. The training cycle then be performed in a supervised manner, supervised learning being a learning method in which training is performed as a mediated operation, such as when the training dataset 210 includes input paired with the desired output for the input, or where the training dataset includes input having known output and the output of the neural network is manually graded. The network processes the inputs and compares the resulting outputs against a set of expected or desired outputs. Errors are then propagated back through the system. The training framework 220 can adjust to modify the weights that control the untrained neural network 230. The training framework 220 can provide tools to monitor how well the untrained neural network 230 is converging towards a model suitable to generating correct answers based on known input data. The training process occurs repeatedly as the weights of the network are adjusted to refine the output generated by the neural network. The training process can continue until the neural network reaches a certain threshold accuracy associated with a trained neural network 240. The trained neural network 240 can then be deployed to implement operations including processing input 250 to generate an output including dynamic price adjustment 260, wherein the dynamic price adjustment relates to a particular sales item. In some embodiments, the output may include a price increase, a price decrease, or a substitute price for a sales item.

FIG. 3 is an illustration of training of a neural network to generate dynamic price adjustments according to some embodiments. In some embodiments, an untrained neural network 230 is trained in a training framework 220 using a training dataset. In some embodiments, the training data set includes a combination of news data 300 and pricing data 320, the training data being historical data regarding news from varying sources and pricing fluctuations that occurred. In this manner, the neural network 230 is trained to generate pricing adjustments based on news data to provide for dynamic price adjustment, such as provided by the dynamic price adjustment function 150 illustrated in FIG. 1.

The news data 300 may be derived from multiple data sources that may have an affect pricing over time. For example, the news data may include, but is not limited to product demand information 310, product analysis information 312, social media data 314, press releases 316, and various new articles 318. Each of the news data is chosen as relating to a particular product or products, and which may thus have some impact on pricing over time. The pricing data 320 then provides information regarding how pricing for a product products trended over time. It is noted that news data 300 and pricing data 320 may relate specifically to a certain product, or may relate a class or category of products, or may generally to an industry or broader economy, depending on the needs or desires of a client for price adjustment.

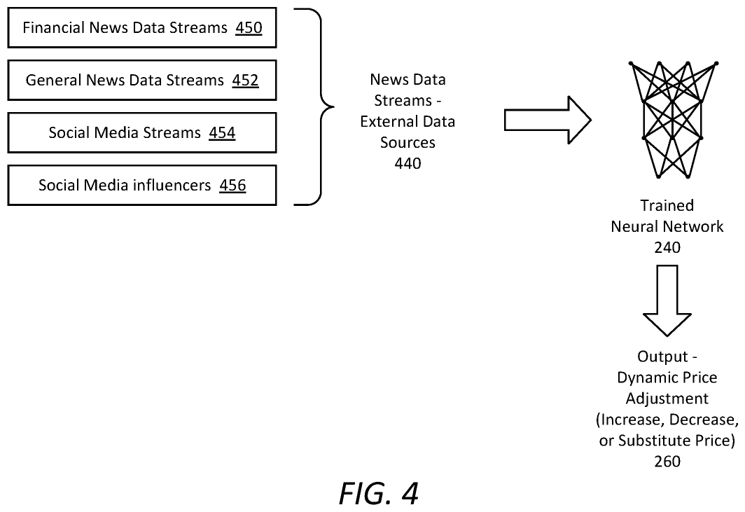

FIG. 4 is an illustration neural network inference to generate dynamic price adjustment according to some embodiments. In some embodiments, a neural network 240 that has been trained to perform dynamic price adjustment, such as the training illustrated in FIG. 4, is applied in dynamic price adjustment, such as provided by the dynamic price adjustment function 150 illustrated in FIG. 1.

In some embodiments, the trained neural network 240 receives one or more streams of news data 440, wherein the data streams may be obtained from one or more external news sources, such as the external news sources 160 illustrated in FIG. 1. In some embodiments, inference by the trained neural network 240 results in an output 260, the output being a dynamic price adjustment for a sales item.

The news data streams may include a variety of different news sources, including, but not limited to, financial new data streams 450, general news data streams 452, social media streams 454, and social media influencer streams 456.

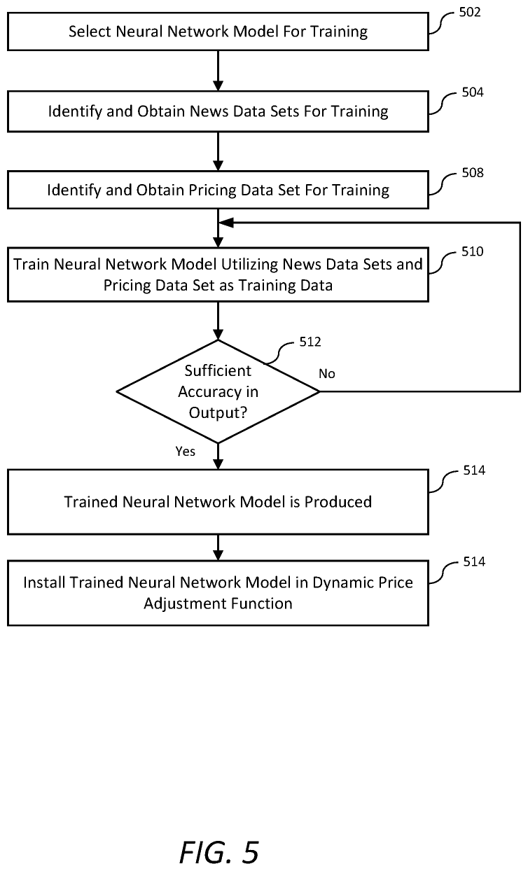

FIG. 5 is a flow chart to illustrate a process for generating a trained neural network for performing dynamic price adjustment according to some embodiments. In some embodiments, a process commences with selection of a neural network model for training 502. The model may be any known neural network model for training, such as a form of a convolutional neural network (CNN) or recurrent neural network (RNN). In some embodiments, one or more new data sets are identified and obtained for use in training 504, and one or more pricing data sets are identified and obtained for training 508.

In some embodiments, the neural network model is then trained utilizing the news data sets and pricing data set as training data 510. In some embodiments, there may a determination whether the neural network is providing sufficient accuracy in generating a pricing adjustment output 512. If not, the neural network may proceed to further training 510 in an attempt to converge to a better result. Upon sufficient accuracy being achieved 512, a trained neural network is then produced 514. In some embodiments, the trained neural network model is then installed in the dynamic price adjustment function, such as the dynamic price adjustment function 150 illustrated in FIG. 1.

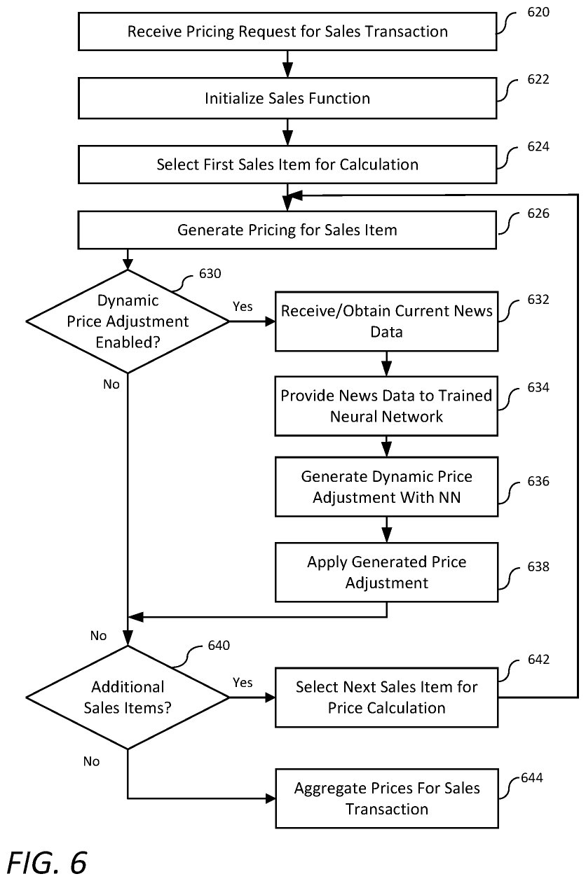

FIG. 6 is a flow chart to illustrate a process for generating a dynamic price adjustment for a sales item utilizing a trained neural network according to some embodiments. In a process, a pricing request for a sales transaction is received 620, such as pricing request received at pricing service 120 illustrated in FIG. 1. The sales transaction may include multiple sales items with each sales item including a certain quantity. In some embodiments, the pricing service is to initialize a sales function 622, and select a first sales item of the sales transaction for calculation 624. The sales function is to generate a pricing for the sales item 626, wherein the pricing determination may include application of a certain pricing plan for the sales item by pricing service 120.

In some embodiments, a determination may be whether dynamic price adjustment is enabled for the sales item in the sales transaction 630. The enablement or disablement of the pricing for the sales item may be dependent on client settings 155 as the settings relate to the particular sales item, customer, or other factor. In this manner, any number of the sales items of the sales transaction may be subject to the dynamic price adjustment depending on the particular client settings for the dynamic price adjustment function.

If the dynamic pricing adjustment is enabled, then the process includes receiving or obtaining current news data 632, and providing the news data to a trained neural network 634, the neural network being trained such as in the process illustrated in FIG. 5. The neural network may be a part of the pricing service, or may be external to the pricing service, such as external neural network 152 illustrated in FIG. 1. A dynamic price adjustment is then generated by the neural network 636, wherein the dynamic adjustment may be a price increase, a price decrease, or application of a substitute price. (The dynamic adjustment may also include no change if no price adjustment is required.) The dynamic price adjustment is then applied to the generated price for the sales item 638.

Upon the dynamic modification of the generated price for a sales item 638, or upon the determination that the dynamic price adjustment is not enabled for the sales item 630, there is a determination whether there are any additional sales items in the sales transaction for price calculation 640. If so, the process includes selecting a next sales item of the sales transaction for price calculation 642, and returning to generating the pricing for the sales item 626. If not, the process proceeds with aggregation of the price of the sales items in the sales transaction 644, which includes any pricing that that has been modified by the dynamic price adjustment.

The examples illustrating the use of technology disclosed herein should not be taken as limiting or preferred. The examples are intended to sufficiently illustrate the technology disclosed without being overly complicated and are not intended to illustrate all of the technologies disclosed. A person having ordinary skill in the art will appreciate that there are many potential applications for one or more implementations of this disclosure and hence, the implementations disclosed herein are not intended to limit this disclosure in any fashion.

One or more implementations may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

Other implementations may include a non-transitory computer readable storage medium storing instructions executable by a processor to perform a method as described above. Yet another implementation may include a system including memory and one or more processors operable to execute instructions, stored in the memory, to perform a method as described above.

Implementations may include:

In some embodiments, one or more non-transitory computer-readable storage mediums having stored thereon executable computer program instructions that, when executed by one or more processors, cause the one or more processors to perform operations including receiving a request at a pricing platform for pricing of one or more sales items in a sales transaction, including a first sales item; generating a price for the first sales item; and determining whether a dynamic price adjustment function is enabled for the first sales item, and, if so, performing the dynamic adjustment price function for the first sales item, including accessing a trained neural network, wherein the neural network is trained for price adjustments based at least in part on training data including news data from one or more sources and data regarding pricing, receiving a dynamic price adjustment for the first sales item from the trained neural network, and applying the dynamic price adjustment to the generated price to produce an adjusted price for the first sales item.

In some embodiments, a system includes one or more processors; a memory to store data; and a pricing service to server a plurality of clients, the pricing service including a price function and a dynamic price adjustment function, wherein the pricing service is to receive a request for pricing of a plurality of sales items in a sales transaction, the plurality of sales items including a first sales item; generate a price for the first sales item; and determine whether the dynamic price adjustment function is enabled for the first sales item, and, if so, perform the dynamic adjustment price function for the first sales item, including: access a trained neural network, wherein the neural network is trained for price adjustments based at least in part on training data including news data from one or more sources and data regarding pricing, receive a dynamic price adjustment for the first sales item from the trained neural network, and apply the dynamic price adjustment to the generated price to produce an adjusted price for the first sales item.

In some embodiments, a method includes receiving a request at a pricing platform for pricing of a plurality of sales items in a sales transaction; generating a price for each sales item of the plurality of sales items; and determining whether a dynamic price adjustment function is enabled for each sales item, and, if so, performing the dynamic adjustment price function for the sales item, including accessing a trained neural network, wherein the neural network is trained for price adjustments based at least in part on training data including news data from one or more sources and data regarding pricing, receiving a dynamic price adjustment for the sales item from the trained neural network, and applying the dynamic price adjustment to the generated price to produce an adjusted price for the sales item.

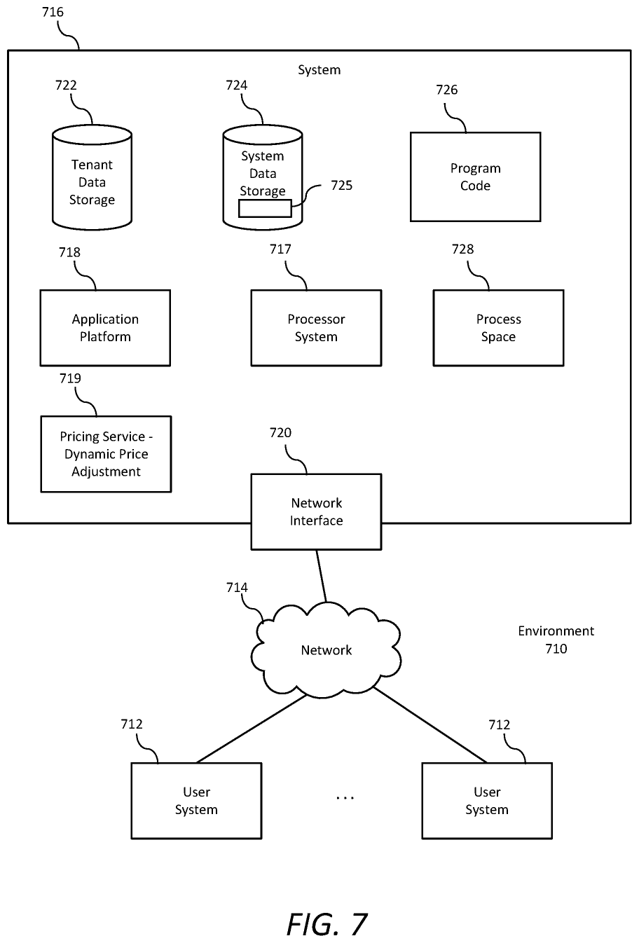

FIG. 7 illustrates a block diagram of an environment in which dynamic price adjustment may be implemented according to some embodiments. In some embodiments, the environment 710 includes a dynamic price adjustment function to apply price adjustments generated by a trained neural network, such as illustrated in FIGS. 1-6, including a pricing service having a dynamic price adjustment function 719. The environment 710 may include user systems 712, network 714, system 716, processor system 717, application platform 718, network interface 720, tenant data storage 722, system data storage 724, program code 726, and process space 728. In other embodiments, environment 710 may not have all of the components listed and/or may have other elements instead of, or in addition to, those listed above.

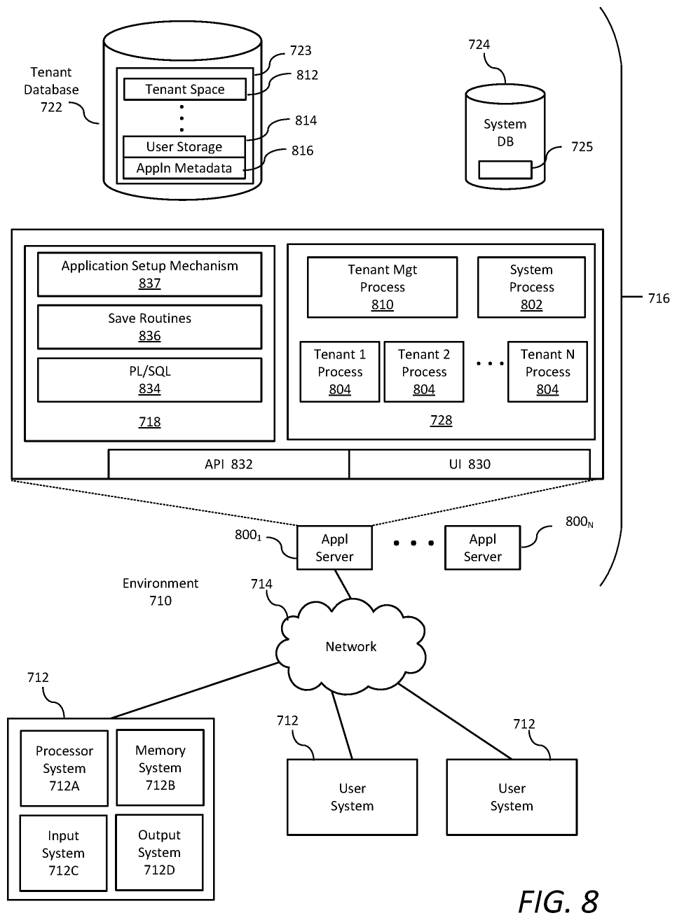

Environment 710 is an environment in which an on-demand database service exists. User system 712 may be any machine or system that is used by a user to access a database user system. For example, any of user systems 712 can be a handheld computing device, a smart phone, a laptop or tablet computer, a work station, and/or a network of computing devices. As illustrated in herein FIG. 7 and in more detail in FIG. 8, user systems 712 may interact via a network 714 with an on-demand database service, such as system 716.

An on-demand database service, such as system 716, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 716” and “system 716” may be used interchangeably herein. A database image may include one or more database objects. A relational database management system (RDMS) or the equivalent may execute storage and retrieval of information against the database object(s). Application platform 718 may be a framework that allows the applications of system 716 to run, such as the hardware and/or software, e.g., the operating system. In an embodiment, on-demand database service 716 may include an application platform 718 that enables creation, managing and executing one or more applications developed by the provider of the on-demand database service, users accessing the on-demand database service via user systems 712, or third-party application developers accessing the on-demand database service via user systems 712.

The users of user systems 712 may differ in their respective capacities, and the capacity of a particular user system 712 might be entirely determined by permissions (permission levels) for the current user. For example, where a salesperson is using a particular user system 712 to interact with system 716, that user system has the capacities allotted to that salesperson. However, while an administrator is using that user system to interact with system 716, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 714 is any network or combination of networks of devices that communicate with one another. For example, network 714 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 712 might communicate with system 716 using TCP/IP and, at a higher network level, use other common Internet protocols to communicate, such as HTTP, FTP, AFS, WAP, etc. In an example where HTTP is used, user system 712 might include an HTTP client commonly referred to as a “browser” for sending and receiving HTTP messages to and from an HTTP server at system 716. Such an HTTP server might be implemented as the sole network interface between system 716 and network 714, but other techniques might be used as well or instead. In some implementations, the interface between system 716 and network 714 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 716, shown in FIG. 7, implements a web-based customer relationship management (CRM) system. For example, in one embodiment, system 716 includes application servers configured to implement and execute CRM software applications as well as provide related data, code, forms, webpages and other information to and from user systems 712 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 716 implements applications other than, or in addition to, a CRM application. For example, system 716 may provide tenant access to multiple hosted (standard and custom) applications, including a CRM application. User (or third-party developer) applications, which may or may not include CRM, may be supported by the application platform 718, which manages creation, storage of the applications into one or more database objects and executing of the applications in a virtual machine in the process space of the system 716.

One arrangement for elements of system 716 is shown in FIG. 7, including a network interface 720, application platform 718, tenant data storage 722 for tenant data 723, system data storage 724 for system data 725 accessible to system 716 and possibly multiple tenants, program code 726 for implementing various functions of system 716, and a process space 728 for executing MTS system processes and tenant-specific processes, such as running applications as part of an application hosting service. Additional processes that may execute on system 716 include database indexing processes.

Several elements in the system shown in FIG. 7 include conventional, well-known elements that are explained only briefly here. For example, each user system 712 could include a desktop personal computer, workstation, laptop or tablet computer, smart phone, or any wireless access protocol (WAP) enabled device or any other computing device capable of interfacing directly or indirectly to the Internet or other network connection. User system 712 typically runs an HTTP client, e.g., a browsing program (also referred to as a web browser or browser), such as Edge or Internet Explorer from Microsoft, Safari from Apple, Chrome from Google, Firefox from Mozilla, or a WAP-enabled browser in the case of a smart phone or other wireless device, or the like, allowing a user (e.g., subscriber of the multi-tenant database system) of user system 712 to access, process and view information, pages and applications available to it from system 716 over network 714. Each user system 712 also typically includes one or more user interface devices, such as a keyboard, a mouse, touch pad, touch screen, pen, voice interface, gesture recognition interface, or the like, for interacting with a graphical user interface (GUI) provided by the browser on a display (e.g., a monitor screen, LCD display, etc.) in conjunction with pages, forms, applications and other information provided by system 716 or other systems or servers. For example, the user interface device can be used to access data and applications hosted by system 716, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 712 and all of its components are operator configurable using applications, such as a browser, including computer code run using a central processing unit such as an Intel Core series processor or the like. Similarly, system 716 (and additional instances of an MTS, where more than one is present) and all of their components might be operator configurable using application(s) including computer code to run using a central processing unit such as processor system 717, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 716 to intercommunicate and to process webpages, applications and other data and media content as described herein are preferably downloaded and stored on a hard disk or solid state drive (SSD), but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™ JavaScript, ActiveX, any other scripting language, such as VBScript, and many other programming languages as are well known may be used. (Java™ is a trademark of Sun Microsystems, Inc.).

According to one embodiment, each system 716 is configured to provide webpages, forms, applications, data and media content to user (client) systems 712 to support the access by user systems 712 as tenants of system 716. As such, system 716 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 8 illustrates further details of an environment in which dynamic price adjustment may be implemented according to some embodiments. FIG. 8 provides further detail regarding elements of system 716. In addition, various interconnections in an embodiment are provided. FIG. 8 shows that user system 712 may include processor system 712A, memory system 712B, input system 712C, and output system 712D. FIG. 8 shows network 714 and system 716. FIG. 8 also shows that system 716 may include tenant data storage 722, tenant data 723, system data storage 724, system data 725, User Interface (UI) 830, Application Program Interface (API) 832, PL/SOQL 834, save routines 836, application setup mechanism 838, applications servers 800₁-800_{N}, system process space 802, tenant process spaces 804, tenant management process space 810, tenant storage area 812, user storage 814, and application metadata 816. In other embodiments, environment 710 may not have the same elements as those listed above and/or may have other elements instead of, or in addition to, those listed above.

User system 712, network 714, system 716, tenant data storage 722, and system data storage 724 were discussed above in FIG. 7. Regarding user system 712, processor system 712A may be any combination of one or more processors. Memory system 712B may be any combination of one or more memory devices, short term, and/or long-term memory. Input system 712C may be any combination of input devices, such as one or more keyboards, mice, trackballs, scanners, cameras, and/or interfaces to networks. Output system 712D may be any combination of output devices, such as one or more monitors, printers, and/or interfaces to networks. As shown by FIG. 8, system 716 may include a network interface 720 (of FIG. 7) implemented as a set of HTTP application servers 800, an application platform 718, tenant data storage 722, and system data storage 724. Also shown is system process space 802, including individual tenant process spaces 804 and a tenant management process space 810. Each application server 800 may be configured to tenant data storage 722 and the tenant data 723 therein, and system data storage 724 and the system data 725 therein to serve requests of user systems 712. The tenant data 723 might be divided into individual tenant storage areas 812, which can be either a physical arrangement and/or a logical arrangement of data. Within each tenant storage area 812, user storage 814 and application metadata 816 might be similarly allocated for each user. For example, a copy of a user's most recently used (MRU) items might be stored to user storage 814. Similarly, a copy of MRU items for an entire organization that is a tenant might be stored to tenant storage area 812. A UI 830 provides a user interface and an API 832 provides an application programmer interface to system 716 resident processes to users and/or developers at user systems 712. The tenant data and the system data may be stored in various databases, such as one or more Oracle™ databases.

Application platform 718 includes an application setup mechanism 838 that supports application developers' creation and management of applications, which may be saved as metadata into tenant data storage 722 by save routines 836 for execution by subscribers as one or more tenant process spaces 804 managed by tenant management process 810 for example. Invocations to such applications may be coded using PL/SOQL 834 that provides a programming language style interface extension to API 832. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 816 for the subscriber making the invocation and executing the metadata as an application in a virtual machine.

Each application server 800 may be communicably coupled to database systems, e.g., having access to system data 725 and tenant data 723, via a different network connection. For example, one application server 800₁ might be coupled via the network 714 (e.g., the Internet), another application server 800_{N-1} might be coupled via a direct network link, and another application server 800_{N} might be coupled by yet a different network connection. Transfer Control Protocol and Internet Protocol (TCP/IP) are typical protocols for communicating between application servers 800 and the database system. However, it will be apparent to one skilled in the art that other transport protocols may be used to optimize the system depending on the network interconnect used.

In certain embodiments, each application server 800 is configured to handle requests for any user associated with any organization that is a tenant. Because it is desirable to be able to add and remove application servers from the server pool at any time for any reason, there is preferably no server affinity for a user and/or organization to a specific application server 800. In one embodiment, therefore, an interface system implementing a load balancing function (e.g., an F5 BIG-IP load balancer) is communicably coupled between the application servers 800 and the user systems 712 to distribute requests to the application servers 800. In one embodiment, the load balancer uses a least connections algorithm to route user requests to the application servers 800. Other examples of load balancing algorithms, such as round robin and observed response time, also can be used. For example, in certain embodiments, three consecutive requests from the same user could hit three different application servers 800, and three requests from different users could hit the same application server 800. In this manner, system 716 is multi-tenant, wherein system 716 handles storage of, and access to, different objects, data and applications across disparate users and organizations.

As an example of storage, one tenant might be a company that employs a sales force where each salesperson uses system 716 to manage their sales process. Thus, a user might maintain contact data, leads data, customer follow-up data, performance data, goals and progress data, etc., all applicable to that user's personal sales process (e.g., in tenant data storage 722). In an example of an MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 716 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 716 might also maintain system level data usable by multiple tenants or other data. Such system level data might include industry reports, news, postings, and the like that are sharable among tenants.

In certain embodiments, user systems 712 (which may be client systems) communicate with application servers 800 to request and update system-level and tenant-level data from system 716 that may require sending one or more queries to tenant data storage 722 and/or system data storage 724. System 716 (e.g., an application server 800 in system 716) automatically generates one or more SQL statements (e.g., one or more SQL queries) that are designed to access the desired information. System data storage 724 may generate query plans to access the requested data from the database.

Each database can generally be viewed as a collection of objects, such as a set of logical tables, containing data fitted into predefined categories. A “table” is one representation of a data object and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, with U.S. Pat. No. 7,779,039, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Embodiments may be provided, for example, as a computer program product which may include one or more machine-readable media (including a non-transitory machine-readable or computer-readable storage medium) having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic tape, magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

While concepts been described in terms of several embodiments, those skilled in the art will recognize that embodiments not limited to the embodiments described but can be practiced with modification and alteration within the spirit and scope of the appended claims. The description is thus to be regarded as illustrative instead of limiting.

What is claimed is:

1. One or more non-transitory computer-readable storage mediums having stored thereon executable computer program instructions that, when executed by one or more processors, cause the one or more processors to perform operations comprising:
receiving a request at a pricing platform for pricing of one or more sales items in a sales transaction, including a first sales item;
generating a price for the first sales item; and
determining whether a dynamic price adjustment function is enabled for the first sales item, and, if so, performing the dynamic adjustment price function for the first sales item, including:
accessing a trained neural network, wherein the neural network is trained for price adjustments based at least in part on training data including news data from one or more sources and data regarding pricing,
receiving a dynamic price adjustment for the first sales item from the trained neural network, and
applying the dynamic price adjustment to the generated price to produce an adjusted price for the first sales item.

2. The mediums of claim 1, wherein the instructions include instructions to perform operations comprising:
obtaining or receiving current news data as input data for the trained neural network, the dynamic price adjustment being based at least in part on the current news data.

3. The mediums of claim 1, wherein the trained neural network is a part of the pricing platform.

4. The mediums of claim 1, wherein the trained neural network is a part of an external system, and wherein the instructions include instructions to perform operations comprising:
providing a request to the external system to infer a price adjustment for the first sales item; and
receiving the inferred price adjustment from the external system.

5. The mediums of claim 1, wherein the news data includes one or more of:
financial news data streams;
general news data streams;
social media streams; and
social media influencer streams.

6. The mediums of claim 1, wherein the sales transaction includes a plurality of sales items, and wherein the instructions include instructions to perform operations comprising:
determining whether the dynamic price adjustment function is enabled for each sales item of the plurality of sales items, and, if so, performing the dynamic adjustment price function for the sales item.

7. The mediums of claim 6, wherein determining whether the dynamic price adjustment function is enabled for each sales item of the plurality of sales items includes accessing one or more settings for the dynamic price adjustment function and determining whether the dynamic price adjustment is enabled based on the one or more settings.

8. The mediums of claim 6, wherein the instructions include instructions to perform operations comprising:
aggregating pricing for the plurality of sales items, including aggregating any prices that are modified by the dynamic price adjustment function.

9. The mediums of claim 1, wherein the dynamic price adjustment is any of a price increase, a price decrease, or application of a substitute price for the first sales item.

10. A system comprising:
one or more processors;
a memory to store data; and
a pricing service to server a plurality of clients, the pricing service including a price function and a dynamic price adjustment function, wherein the pricing service is to:
receive a request for pricing of a plurality of sales items in a sales transaction, the plurality of sales items including a first sales item;
generate a price for the first sales item; and
determine whether the dynamic price adjustment function is enabled for the first sales item, and, if so, perform the dynamic adjustment price function for the first sales item, including:
access a trained neural network, wherein the neural network is trained for price adjustments based at least in part on training data including news data from one or more sources and data regarding pricing,
receive a dynamic price adjustment for the first sales item from the trained neural network, and
apply the dynamic price adjustment to the generated price to produce an adjusted price for the first sales item.

11. The system of claim 10, wherein performing the dynamic price adjustment function includes the pricing service to:
obtain or receive current news data as input data for the trained neural network, the dynamic price adjustment being based at least in part on the current news data.

12. The system of claim 10, wherein system includes the trained neural network.

13. The system of claim 10, wherein the trained neural network is a part of an external system, and wherein the pricing service is to:
provide a request to the external system to infer a price adjustment for the first sales item; and
receive the inferred price adjustment from the external system.

14. The system of claim 10, wherein the news data includes one or more of:
financial news data streams;
general news data streams;
social media streams; and
social media influencer streams.

15. The system of claim 10, wherein the pricing service is to:
determine whether the dynamic price adjustment function is enabled for each sales item of the plurality of sales items, and, if so, perform the dynamic adjustment price function for the sales item.

16. The system of claim 15, further comprising one or more settings for the dynamic price function, and wherein determining whether the dynamic price adjustment function is enabled for each sales item of the plurality of sales items includes accessing the one or more settings for the dynamic price adjustment function and determining whether the dynamic price adjustment is enabled based on the one or more settings.

17. A method comprising:
receiving a request at a pricing platform for pricing of a plurality of sales items in a sales transaction;
generating a price for each sales item of the plurality of sales items; and
determining whether a dynamic price adjustment function is enabled for each sales item, and, if so, performing the dynamic adjustment price function for the sales item, including:
accessing a trained neural network, wherein the neural network is trained for price adjustments based at least in part on training data including news data from one or more sources and data regarding pricing,
receiving a dynamic price adjustment for the sales item from the trained neural network, and
applying the dynamic price adjustment to the generated price to produce an adjusted price for the sales item.

18. The method of claim 17, further comprising:
obtaining or receiving current news data as input data for the trained neural network, the dynamic price adjustment being based at least in part on the current news data.

19. The method of claim 17, further comprising receiving one or more settings for the dynamic price adjustment function, wherein determining whether the dynamic price adjustment function is enabled for each sales item of the plurality of sales items includes accessing the one or more settings for the dynamic price adjustment function and determining whether the dynamic price adjustment is enabled based on the one or more settings.

20. The method of claim 17, further comprising:
obtaining news data and pricing data for neural network training;
performing training of a untrained neural network, including applying the news data and pricing data to the untrained neural network, and
training the neural network until a threshold accuracy is reached to generate the trained neural network.
